(19) United States
(12) Patent Application Publication
(10) Pub. No.: US 2010/0205141 A1
(43) Pub. Date: Aug. 12, 2010

(54) METHOD, SYSTEM AND COMPUTER PROGRAM PRODUCT FOR DATA COLLECTION AND RETRIEVAL FOR MEDICAL RESEARCH

(76) Inventor: Indu Rekha Meesa, Grand Rapids, MI (US)

Correspondence Address: Indu Rekha Meesa, 4593 Woodcreek Drive, Grand Rapids, MI, 49546, US

(21) Appl. No.: 12/497,658

(22) Filed: Jul. 4, 2009

Related U.S. Application Data
(60) Provisional application No. 61/150,641, filed on Feb. 6, 2009.

(51) Int. Cl. G06F 17/30

(52) U.S. Cl. 707/602; 707/E17.014; 707/E17.044

(57) ABSTRACT

A method, system and computer program product for data collection and retrieval for medical research includes selecting at least one group of medical documents, from a plurality of medical document groups, to retrieve documents from. Search criteria is supplied for a search in the at least one group and a report is generated including medical documents matching the search criteria. Medical data is extracted from source medical systems. The extracted data is transported using flat files. The flat files are transformed and loaded into a central warehouse database, wherein the central warehouse database includes a master table and a medical data table, and the search is performed on the at least a portion of the central warehouse database. Records in the source medical systems are standardized.

### CROSS-REFERENCE TO RELATED APPLICATIONS

The present Utility patent application claims priority benefit of the U.S. provisional application for patent Ser. No. 61/150,641 filed on 6 Feb. 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to medical research. More particularly, the invention relates to electronic data collection and retrieval for radiology research.

### BACKGROUND OF THE INVENTION

Advances in medicine are achieved by performing research. Clinical research involves developing new diagnoses, monitoring responses to therapy (i.e., chemotherapy and radiation), and monitoring progression of diseases. With electronic medical records (EMR) and picture archiving and communications systems (PACS), medicine has advanced to a point where almost all patient data is stored electronically.

Currently, the most tedious and time-consuming part of research is data collection. However, with electronic data storage, data collection should become quite simplified. Based on the medical record number (MRN), name, or date of birth (DOB) existing systems are able to retrieve patient information in a matter of a few seconds. It is therefore an objective of the present invention to provide a research application where the researcher enters the data he or she would like to retrieve (e.g., radiology reports, pathology, cardiology documents, etc.) in a user-friendly form and, based on the search criteria they input, the application generates a report comprising these requirements.

In view of the foregoing, there is a need for improved techniques for providing an electronic data collection and retrieval system for medical research.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary end user form for a search using electronic data collection for radiology research, in accordance with an embodiment of the present invention;

FIG. 2 illustrates an exemplary EMR database for use with an exemplary electronic data collection application, in accordance with an embodiment of the present invention;

FIG. 3 is a flowchart illustrating an exemplary process for building a data warehouse to integrate data across multiple medical centers for research, in accordance with an embodiment of the present invention; and

FIG. 4 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for data collection and retrieval for medical research is presented.

In one embodiment a method for data collection and retrieval for medical research is presented. The method includes step for selecting at least one group of medical documents, steps for supplying search criteria and steps for generating a report including medical documents matching the search criteria. Another embodiment further includes steps for extracting medical data from source medical systems. Yet another embodiment further includes steps for transporting the extracted data. Still another embodiment further includes steps for transforming and loading a central warehouse database with the extracted medical data, wherein the central warehouse database includes a master table and a medical data table. Another embodiment further includes steps for standardizing records in the source medical systems.

In another embodiment a method for data collection and retrieval for medical research is presented. The method includes the steps of selecting at least one group of medical documents, from a plurality of medical document groups, to retrieve documents from, supplying search criteria for a search in the at least one group and generating a report including medical documents matching the search criteria. Another embodiment further includes the step of extracting medical data from source medical systems. Yet another embodiment further includes the step of transporting the extracted data using flat files. Still another embodiment further includes the step of transforming the flat files and loading a central warehouse database with the extracted medical data, wherein the central warehouse database includes a master table and a medical data table, and the search is performed on the at least a portion of the central warehouse database. Another embodiment further includes the step of standardizing records in the source medical systems.

In another embodiment a system for data collection and retrieval for medical research is presented. The system includes means for selecting at least one group of medical documents, from a plurality of medical document groups, to retrieve documents from, means for supplying search criteria for a search in the at least one group and means for receiving a report including medical documents matching the search criteria. Another embodiment further includes means for extracting medical data from source medical systems. Yet another embodiment further includes means for transporting the extracted data using flat files. Still another embodiment further includes means for transforming the flat files and loading a central warehouse database with the extracted medical data, wherein the central warehouse database includes a master table and a medical data table, and the search is performed on the at least a portion of the central warehouse database. Another embodiment further includes means for standardizing records in the source medical systems.

In another embodiment a computer program product for data collection and retrieval for medical research is presented. The computer program product including computer program code for selecting at least one group of medical documents, from a plurality of medical document groups, to retrieve documents from, computer program code for supplying search criteria for a search in the at least one group, computer program code for generating a report including medical documents matching the search criteria and a computer-readable media for storing the computer program code. Another embodiment further includes computer program code for extracting medical data from source medical systems. Yet another embodiment further includes computer program code for transporting the extracted data using flat files. Still another embodiment further includes computer program code for transforming the flat files and loading a central warehouse database with the extracted medical data, wherein the central warehouse database includes a master table and a medical data table, and the search is performed on the at least a portion of the central warehouse database. Another embodiment further includes computer program code for standardizing records in the source medical systems.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Preferred embodiments of the present invention provide a research application where a researcher enters the data he would like to retrieve (e.g., radiology reports, pathology, cardiology documents, etc.) based on search criteria he inputs. In preferred embodiments, the users input their requirements into a user-friendly form.

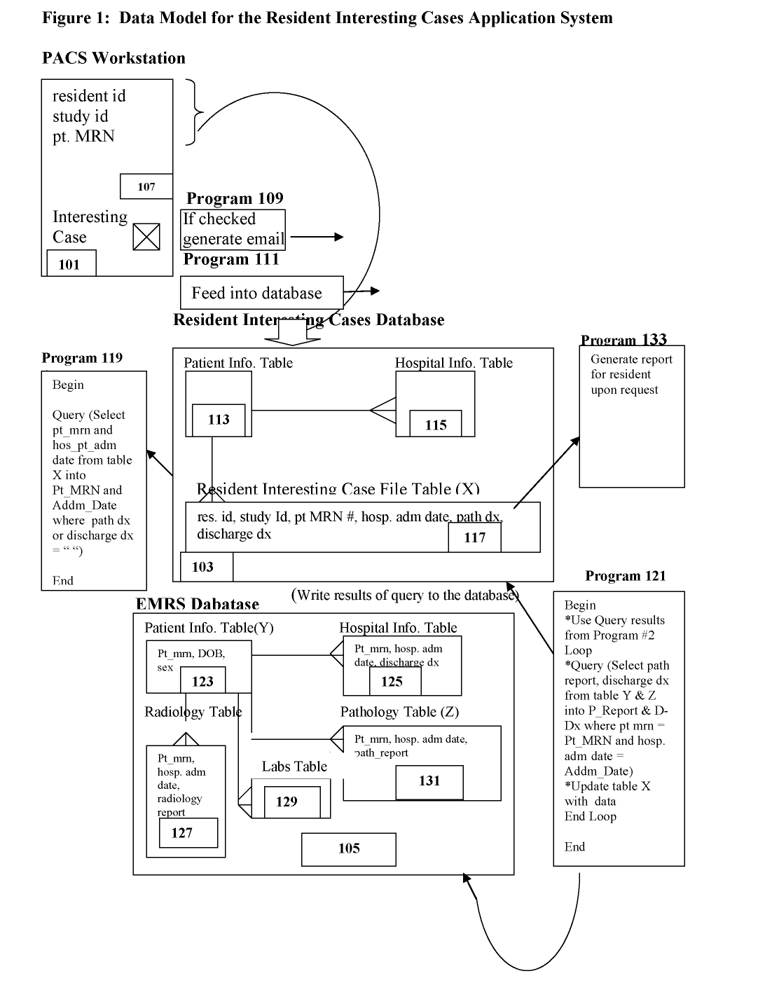

FIG. 1 illustrates an exemplary end user form for a search using electronic data collection for radiology research, in accordance with an embodiment of the present invention. The form comprises multiple drop down boxes from which a researcher chooses documents for which to search. In the present embodiment, the form comprises a radiology documents drop down box 101, a cardiology documents drop down box 103, a pathology drop down box 105, and a diagnosis drop down box 107. In alternate embodiments, the end user form may comprise various different drop down boxes to search for different types of documents or other information such as, but not limited to, Clinic documents, History and Physicals, and Discharge Documents, Emergency Room documents, etc. Radiology documents drop down box 101 enables the researcher to search for radiographs, ultra sounds, CTs, MRIs, nuclear medicine documents, mammography documents, fluoroscopy studies, or all of these. Cardiology documents drop down box 103 enables the researcher to choose to search for echocardiograms, stress tests or cardiac caths. Pathology drop down box 105 enables the researcher to choose to search for a pathology diagnosis. Diagnosis drop down box 107 enables the researcher to choose to search for a primary diagnosis or a secondary diagnosis. Those skilled in the art, in light of the present teachings, will readily recognize that a multiplicity of alternate documents or other information may be included in the drop down boxes such as, but not limited to, Clinic documents, History and Physicals, and Discharge Documents, Emergency Room documents, etc.

In the present embodiment, the end user form also comprises fields to enable the researcher to enter search criteria including, but not limited to, age range fields 109, date range fields 111, a complaint field 113, a location field 115, and a primary diagnosis field 117. In alternate embodiments the end user form may comprise additional or alternate fields in which the researcher may enter search criteria such as, but not limited to, a MRN field, a patient sex field, a physician field, a hospital field, etc BMI range, surgery type, medication, age range, sex (M vs. F). Once the researcher enters all of his required criteria into the end user form in the present embodiment, he presses a submit button 119 and the application generates a report based on his requirements.

In a non-limiting example of the use of the present embodiment, a researcher would like to analyze CT and MRI imaging findings in patients presenting with shock to the ICU over last 3-4 years. In this case the researcher chooses CT and MRI from radiology documents drop down box 101, enters dates corresponding to the last four years in date range fields 111 and enters shock into primary diagnosis field 115. In another non-limiting example, a researcher would like to see if there is an association between cardiomegaly seen on plain films and obesity using body mass index (BMI) as an index for obesity measurement in young patients. If there is, patients may require further work up for coronary artery disease (CAD) and carotid artery disease. Another user form would be used: user would choose radiographs from radiology documents drop down box 101, would choose echocardiogram from drop down box 103, and enter cardiomegaly into primary diagnosis field 115. BMI range would be selected in the BMI field.

In order to make effective use of existing data for an electronic data collection system in accordance with the present embodiment, current electronic medical records applications must be modified. These modifications change certain fields to values from a list of preset values for that field. For example, without limitation, for radiology reports, the final impression field must be changed so that the physician selects from preset values for the impression such as, but not limited to, possible values for ct thorax include: positive for pulmonary emboli, negative for pulmonary emboli, positive for pneumothorax, negative for pneumothorax, pneumonia, pulmonary fibrosis, pulmonary nodules, primary lung cancer, metastatic lung cancer, etc. Possible values for head CT include: positive for intracranial hemorrhage, negative for intracranial hemorrhage, positive for stroke, negative for stroke, positive for mass effect, negative for mass effect etc. Possible values for MRI of brain include: positive for primary tumor, negative for primary tumor, positive for bleed, negative for bleed, positive for stroke, negative for stroke, positive for metastatic disease, negative for metastatic disease. Each imaging exam, there fore would have pre-defined pertinent positive and negative values. Each study could have multiple entries. For example, a person can have lung tumor and a pulmonary emboli on a chest CT. After selecting preset values, the physician can enter additional information such as, but not limited to, he can describe the tumor by giving measurements, and he can describe the nodules and their size, etc. The history and physical reports and discharge reports must also be changed by directing the physician to select from a preset list of values. Additional information can also be entered in text boxes for these fields. ALL THE DOCUMENTS THAT THE PHYSICIANS DICTATE (RADIOLOGY REPORTS, HISTORY AND PHYSICALS AND DISCHARGE SUMMARIES, EMERGENCY DEPARTMENT DOCUMENTS, AND CLINIC NOTES) CAN BE MODIFIED. THIS WILL CREATE UNIFORMITY AND STANDARDIZATION AND WILL ALLOW EASY RETRIEVAL FOR RESEARCH PURPOSES. The modification of the data enables the application to easily search for these preset values rather than searching for multiple possible values for a particular field. This modification is required because currently the existing system does not allow for retrieval of data based on diagnosis. The existing system does not allow the physicians to commit to one or two diagnosis or even multiple diagnoses. Because the electronic system does not mandate entries, there is no standardization.

In an exemplary method for modification to radiology reports based on the examination type according to the present embodiment, a drop down box under the impression field displays relevant diagnoses. For example, without limitation, if the examination type is CT Thorax with IV contrast, under diagnoses in the drop down box, pulmonary emboli, pulmonary nodules and pneumonia are displayed. A text box is also displayed for additional findings and comments. The exam type describes the location and the modality along with contrast usage. For modification to history and physical reports and discharge reports, the physician selects from a preset list of admit and discharge diagnoses. A text box is also displayed in which additional findings and comments may be entered.

In the present embodiment, security is implemented to protect patients by assigning roles with different access levels to users in the research team. For example, without limitation, a faculty physician may have full access while the access granted to residents, medical students and research administrative assistants is determined by the faculty physician. Examples of different access levels include, without limitation, query access and view only access. In the above example the principal investigator, the faculty physician, is given query access which gives him access to the query form so that he may perform searches using the query form. The faculty physician also determines the level of access the residents, medical students, and research administrative assistants are granted for that particular project. If a researcher has view only assess, he may only view results generated by searches performed by users who have query access.

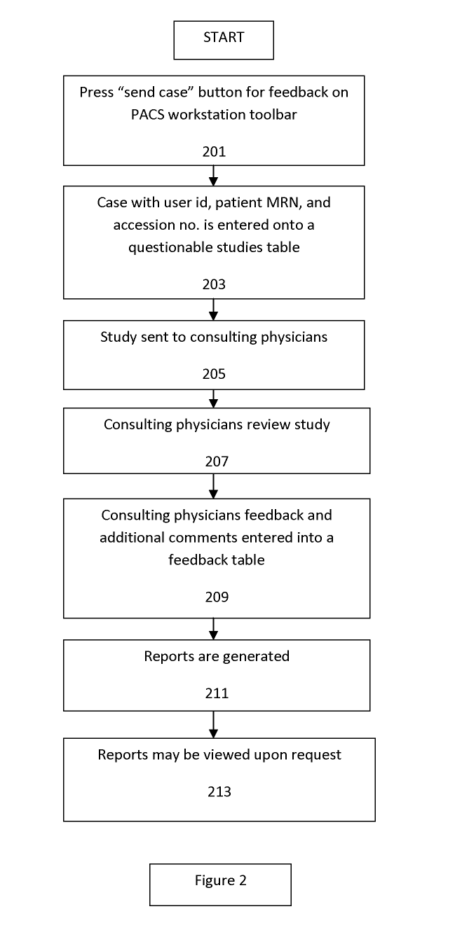

FIG. 2 illustrates an exemplary EMR database 201 for use with an exemplary electronic data collection application, in accordance with an embodiment of the present invention. EMR database 201 comprises a master table 203 and an electronic medical data collection table 205. In the present embodiment, master table 201 comprises data pertaining to the MRN, date of birth, admit date, discharge date, history and physical reports, etc. This data includes, without limitation, radiology documents 207, lab documents 209, surgery documents 211, pathology documents 213, cardiology documents 215, clinic documents 217, etc. Those skilled in the art, in light of the present teachings, will readily recognize that the master table in alternate embodiments may comprise additional or alternate data or may omit some of the data shown in the present embodiment. In the present embodiment, electronic medical data collection table 205 comprises information pertaining to the MRN, date of birth, primary diagnosis, secondary diagnosis, radiology documents, pathology, cardiology, etc. In alternate embodiments, the electronic medical data collection table may comprise additional or different data or may omit some of the data shown in the present embodiment. In the present embodiment, electronic medical data table 205 is populated from master table 203 by a population program. The logic for an exemplary population program is shown by way of example in Table 1. Once electronic medical data collection table 205 is populated, the application can generate a report for a search with a report program. An exemplary report program is shown by way of example in Table 2. The report comprises information including, but not limited to, the primary and any secondary diagnoses, radiology documents, pathology documents, and cardiology documents. Those skilled in the art, in light of the present teachings, will readily recognize that the report in alternate embodiments may comprise additional or alternate information or may omit some of the information shown in the present embodiment. Some embodiments may enable the user to customize the information that he would like to receive in the report.

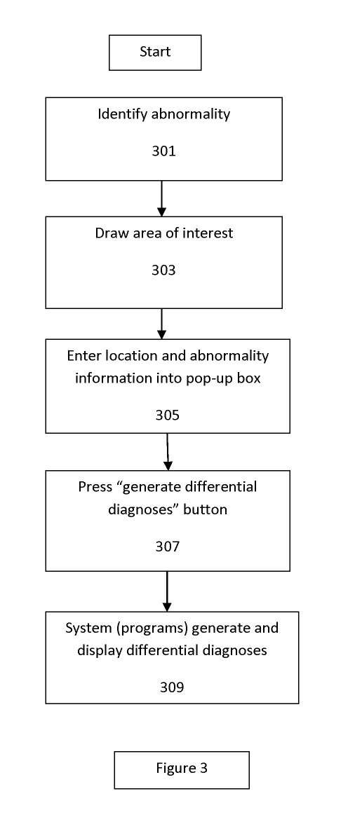

FIG. 3 is a flowchart illustrating an exemplary process for building a data warehouse to integrate data across multiple medical centers for research, in accordance with an embodiment of the present invention. The process begins at step 301 where a database for the central data warehouse is designed and developed. The database for the central data warehouse is preferably based on the following data for each case: organ system and associated pathology, treatment, and response to treatment. Each organ system is unique and therefore has unique anatomy, physiology, and pathologies that affect it. For research purposes, it might be best suited if the dataware house is organized in such manner. For example if the researcher wants to specifically locate a type of brain tumor and determine the most commonly used treatment across centers, such a design will enable for easy query and retrieval of data. However, in alternate embodiments the database for the central data warehouse may be based on other case data including, but not limited to, the dataware house database could also be based on disease process. For example, disorders such as rheumatoid, multiple myeloma, sarcoidosis, and scleroderma involve multiple organ systems. Two different databases might be required for the adults and children as these two age groups often have different pathologies. In the present embodiment, software applications to perform extraction, transportation, transformation, and loading from source systems (i.e., medical centers across the nation) to the central data warehouse database are designed and developed in step 303. Extraction applications run at a predetermined interval for example, without limitation, once a month, once a week, daily, etc. An exemplary extraction application connects to the source systems to access source tables or data in a preconfigured manner. Then, an exemplary transportation application uploads medical electronic data from electronic medical records (EMR) in the source tables extracted by the extraction application into flat files and transports this electronic data to a target platform using file transfer protocol (FTP). Exemplary transformation and loading applications move the data from the flat files into the central data warehouse. Finally, in step 305 a program is developed to generate reports from the database in central data warehouse for research purposes.

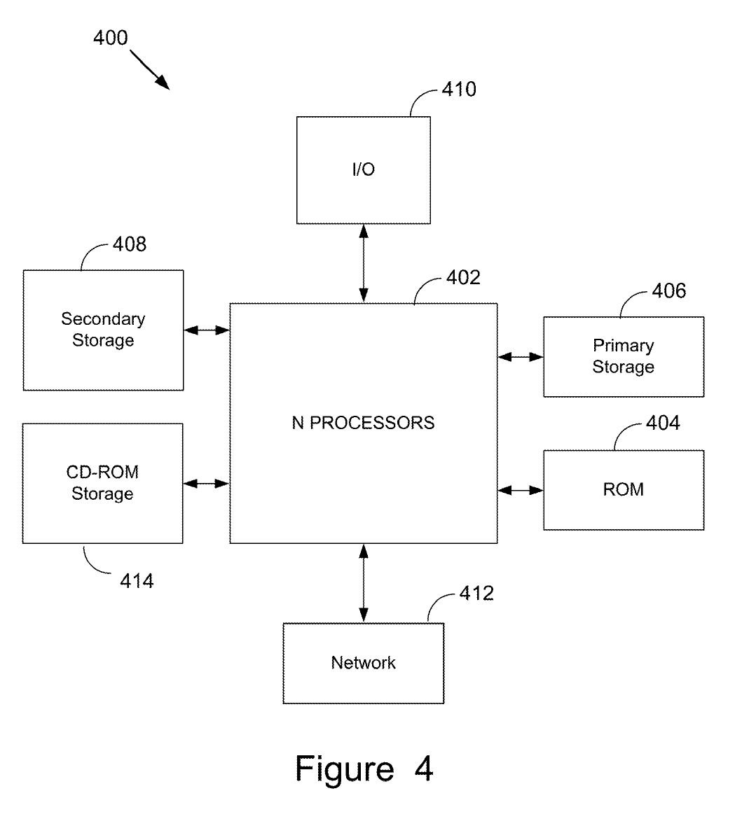

FIG. 4 illustrates a typical computer system that, when appropriately configured or designed, can serve as a computer system in which the invention may be embodied. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally at 412, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the databases and the programs populating the databases and retrieving data from the databases may be performed and/or located outside of the jurisdiction of the USA while the remaining method steps and/or system components of the forgoing embodiments are typically required to be located/performed in the US for practical considerations.

TABLE 1
Program 1

| | Purpose: To populate the Electronic Medical Data Collection table based on the user | | |
|---|---|---|---|
| | input. | | |
| | Logic: | | |
| | Once “SUBMIT” is pressed, data is collected from the input fields and a query is | | |
| | generated: | | |
| | Select mrn, dob into var a and var b from master table where date range = ‘X’, age = | | |
| | ‘Y’, location = ‘Z’, primary dx = ‘A’, chief complaint = ‘B’ etc... | | |
| | | Begin Loop: | |
| | | Select mrn, dob, diagnosis, rad reports, cardiology reports, and pathology into | |
| | report_mrn, | | |
| | | report_dob, report_diagnosis, report_radreports, report_cardiologyreport, | |
| | | report_pathologyreport from table Radiology where mrn = var a and dob = var | |
| | b, Cardiology | | |
| {open oversize brace} | | where mrn = var a and dob = var b, Pathology where mrn = var a and dob = var | {close oversize brace} |
| | b; | | |

Begin Loop:

| | Add each record from above into the Electronic Medical Data | |
|---|---|---|
| {open oversize brace} | Collection table | {close oversize brace} |

End Loop

End Loop:

TABLE 2
Program 2:

Purpose: Generate the report
Logic:
Select MRN, DOB, Primary Dx, Secondary Dx, Radiology Documents,
Pathology, Cardiology Documents from Electronic Medical Data
Collection table; (Figures 1 & 2)

Having fully described at least one embodiment of the present invention, other equivalent or alternative methods of providing an electronic data collection and retrieval system for medical research according to the present invention will be apparent to those skilled in the art. The invention has been described above by way of illustration, and the specific embodiments disclosed are not intended to limit the invention to the particular forms disclosed. For example, the particular implementation of the databases and query forms may vary depending upon the particular type of medical field being researched. The databases and query forms described in the foregoing were directed to radiology implementations; however, similar techniques are to provide electronic data collection and retrieval systems for medical fields other than radiology such as, but not limited to, oncology, cardiology, surgery, neurology, etc. Non-radiology implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method for data collection and retrieval for medical research, the method comprising:
step for selecting at least one group of medical documents;
steps for supplying search criteria; and
steps for generating a report comprising medical documents matching said search criteria.

2. The method as recited in claim 1, further comprising steps for extracting medical data from source medical systems.

3. The method as recited in claim 2, further comprising steps for transporting said extracted data.

4. The method as recited in claim 3, further comprising steps for transforming and loading a central warehouse database with said extracted medical data, wherein said central warehouse database comprises a master table and a medical data table.

5. The method as recited in claim 2, further comprising steps for standardizing records in said source medical systems.

6. A method for data collection and retrieval for medical research, the method comprising the steps of:
selecting at least one group of medical documents, from a plurality of medical document groups, to retrieve documents from;
supplying search criteria for a search in said at least one group; and
generating a report comprising medical documents matching said search criteria.

7. The method as recited in claim 6, further comprising the step of extracting medical data from source medical systems.

8. The method as recited in claim 7, further comprising the step of transporting said extracted data using flat files.

9. The method as recited in claim 8, further comprising the step of transforming said flat files and loading a central warehouse database with said extracted medical data, wherein said central warehouse database comprises a master table and a medical data table, and said search is performed on said at least a portion of said central warehouse database.

10. The method as recited in claim 7, further comprising the step of standardizing records in said source medical systems.

11. A system for data collection and retrieval for medical research, the system comprising:
means for selecting at least one group of medical documents, from a plurality of medical document groups, to retrieve documents from;
means for supplying search criteria for a search in said at least one group; and
means for receiving a report comprising medical documents matching said search criteria.

12. The system as recited in claim 11, further comprising means for extracting medical data from source medical systems.

13. The system as recited in claim 12, further comprising means for transporting said extracted data using flat files.

14. The system as recited in claim 13, further comprising means for transforming said flat files and loading a central warehouse database with said extracted medical data, wherein said central warehouse database comprises a master table and a medical data table, and said search is performed on said at least a portion of said central warehouse database.

15. The system as recited in claim 12, further comprising means for standardizing records in said source medical systems.

16. A computer program product for data collection and retrieval for medical research, the computer program product comprising:
computer program code for selecting at least one group of medical documents, from a plurality of medical document groups, to retrieve documents from;
computer program code for supplying search criteria for a search in said at least one group;
computer program code for generating a report comprising medical documents matching said search criteria; and
a computer-readable media for storing said computer program code.

17. The computer program product as recited in claim 16, further comprising computer program code for extracting medical data from source medical systems.

18. The computer program product as recited in claim 17, further comprising computer program code for transporting said extracted data using flat files.

19. The computer program product as recited in claim 18, further comprising computer program code for transforming said flat files and loading a central warehouse database with said extracted medical data, wherein said central warehouse database comprises a master table and a medical data table, and said search is performed on said at least a portion of said central warehouse database.

20. The computer program product as recited in claim 17, further comprising computer program code for standardizing records in said source medical systems.
